(19) United States
(12) Patent Application Publication
(10) Pub. No.: US 2004/0005868 A1
(43) Pub. Date: Jan. 8, 2004

(54) Method for controlling access to a determined space via a personalised portable object, and portable object for implementing the same

(76) Inventors: Olivier Desjeux, Le Landeron (CH); Thierry Roz, Les Hauts-Geneveys (CH)

Correspondence Address: Richard K. Robinson, Attorney at Law, North Dallas Bank Tower, Suite 1202, 12900 Preston Road, LB-41, Dallas, TX, 75230, US

(21) Appl. No.: 10/612,130

(22) Filed: Jul. 2, 2003

(30) Foreign Application Priority Data
Jul. 5, 2002 (EP) 02077681.1

(51) Int. Cl. H04B 1/44

(52) U.S. Cl. 455/90.1; 455/95; 455/550.1; 455/78; 455/88

(57) ABSTRACT

The method for controlling access by a personalised portable object (2) to a determined space is achieved by wireless transmission of an encoded identification signal. In order to do this, electronic means are provided in the space, whereas the portable object includes a processing unit (26) connected to signal transmission (22, 28) and/or reception means (21, 17). An encoded identification signal is transmitted by the transmission means of the portable object (2) or by transmission means provided in the determined space. This encoded identification signal is received by reception means provided in the space or in the portable object, when the object is located in a restricted zone around the electronic means provided in the space. The received encoded signal is verified in the electronic means provided in the space or in the processing unit (26) to authorise access to the space. The encoded identification signal transmitted and received includes an analogue signature specific to the pair formed by the personalised portable object (2) and the electronic means provided in the space. Thus, verification consists in comparing this analogue signature with a stored reference signature in order to authorise access to the space if said signature is recognised.

The invention concerns a method for controlling access by a personalised object, to a determined space, such as a vehicle, via the wireless transmission of an encoded identification signal. In order to do this, electronic means are provided in the space. These electronic means include, in particular, access control means connected to means for receiving and/or transmitting signals. The portable object for controlling access includes a processing unit connected to signal transmission means and/or reception means. The method for controlling access to the space consists first of all in transmitting an encoded identification signal by the transmission means of the portable object or respectively by the transmission means provided in the determined space. This encoded signal is then received by the reception means in the space or respectively by the reception means of the portable object, when the object is in a restricted zone around reception means and/or transmission means provided in the space. Verification of the encoded signal is carried out in the access control means or in the processing unit to authorise access to the space.

The invention also concerns a personalised portable object for access to the determined space. This portable object includes, in particular, a signal processing unit connected to signal transmission means and/or reception means so as to transmit or receive an encoded identification signal for access to the determined space.

Using the access control method, it is possible to authorise access to a person provided with the personalised portable object in a determined space after verification of the encoded identification signal of the object and the space to be accessed. Transmission of the encoded signal can be automatically started as soon as the presence of the object has been detected in a restricted zone around transmission means and/or reception means provided in the space. This encoded signal transmission can also be started manually by activating control means of the object or the space. This encoded signal transmission can thus be made from the object to the reception means provided in the space or conversely from the transmission means provided in the space to the object. As soon as the received encoded signal has been recognised in the means for controlling access to the space or in the processing unit of the object, it is then possible to access the space.

The determined space can be a security enclosure, a safe, a secured chamber or building with an access door controlled by the portable object, a vehicle, or any other space to which entry is only permitted to authorised persons. The access authorisation allows, for example a door of the enclosure, safe or secured building to be unlocked or locked. Preferably, the space is defined by the inside of a road vehicle, such as a private car, the doors and boot of which can be locked or unlocked by remote control using a personalised portable object.

The personalised portable object may be an electronic key, a watch, a portable telephone, a smart card, a badge or any other portable device. Preferably, this portable object is an electronic key for controlling access to a vehicle. This portable object can include its own energy source for powering its electronic components. In such case, the portable object is of the active type. The electric power supply of said electronic components can also originate from a signal with a determined carrier frequency, which is transmitted by transmission means provided in the space and which is received by the portable object. In such case, the portable object is of the passive type. However, with a passive type portable object, a high frequency signal has to be transmitted from the transmission means provided in the space to provide sufficient electric power to the electronic components of the object. This is why, in the field of the remote control of parts or functions of a vehicle, the portable object, which is an electronic key, is preferably of the active type.

The electronic key includes, in particular, a micro-controller connected to storage means in which a cipher algorithm and/or an access code to the vehicle are stored. As soon as pressure is applied to a control button of the key, the micro-controller calculates an encoded identification signal to transmit via signal transmission means towards the vehicle. Once the encoded signal received by the vehicle has been recognised, a command is issued for locking or unlocking the parts or functions of the vehicle.

In order to facilitate access to the vehicle without having to handle the electronic key, there has already been proposed an electronic key whose response signal is automatically transmitted to the vehicle as a function of an interrogation signal received from the vehicle. In order to do this, the key has to be in a restricted zone around the vehicle in order to receive this interrogation signal originating from the vehicle. Moreover, the key only transmits a response signal to the vehicle if the interrogation signal has been recognised by the key. This response signal thus controls the locking and unlocking of parts or functions of the vehicle.

With thus use of such an electronic key automatically controlled by the interrogation signal originating from the vehicle, there is a risk of the vehicle being unlocked by intermediate relays unknown to the person carrying the electronic key. Consequently, this gives ill-intentioned persons the possibility of using these intermediate relays between the vehicle and the person carrying the electronic key to unlock the vehicle and start it. Said relays are able to reproduce towards the key, respectively towards the vehicle, the interrogation signal or respectively the response signal, which each include a binary data sequence.

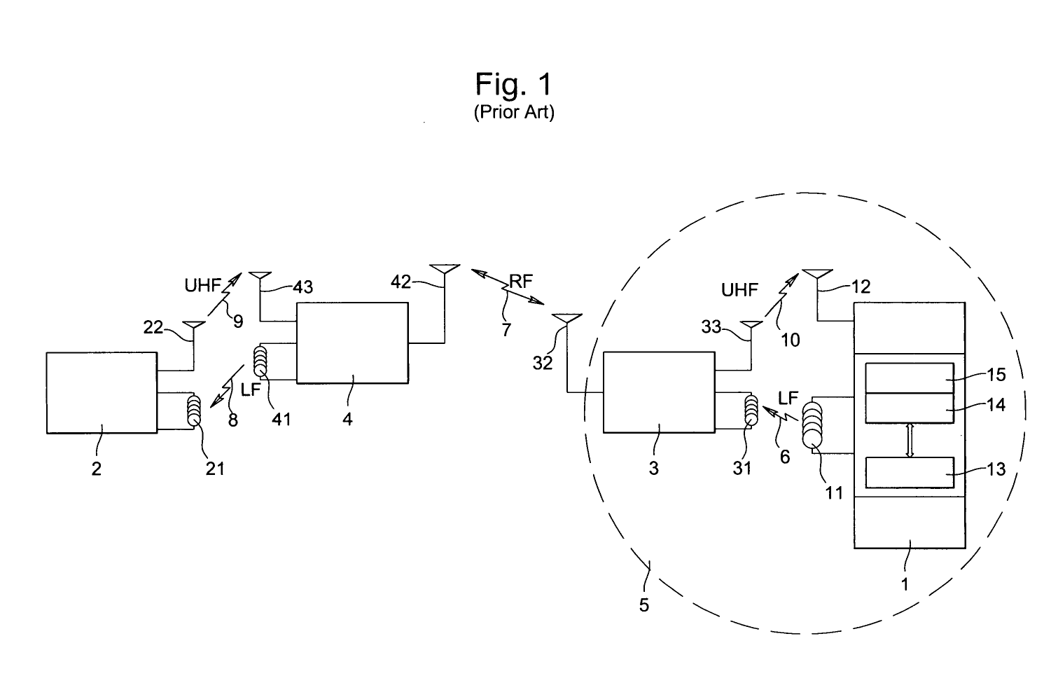

FIG. 1 shows schematically the principle of attack by intermediate relays. The two relays are placed respectively in proximity to a portable object, such as an automatically controlled electronic key, and the associated vehicle.

In a normal situation without the relays, the person carrying portable object 2 has to be in a restricted zone 5 around vehicle 1 to control unlocking of the locked vehicle, since interrogation signal 6, 8 transmitted by an antenna 11 of signal transmission means 14 of the vehicle, can only be detected at a short distance. This interrogation signal has a low carrier frequency LF, for example of the order of 125 kHz. A binary data sequence in the interrogation signal is for example generated by modulating the amplitude of the carrier. An antenna 21 of the reception means of object 2 can only detect this low frequency signal in a zone around the vehicle, which does not exceed, for example, 2 meters. Once the interrogation signal has been able to be checked by the portable object, an antenna 22 of the transmission means of the portable object transmits a response signal 9, 10. This response signal has a high frequency carrier frequency UHF, for example of the order of 433 MHz. An antenna 12 of reception means 15 of the vehicle picks up this response signal. Access control means 13 connected to the transmission means and the reception means of the vehicle will issue a command for unlocking the doors and boot of the vehicle as soon as the response signal is received.

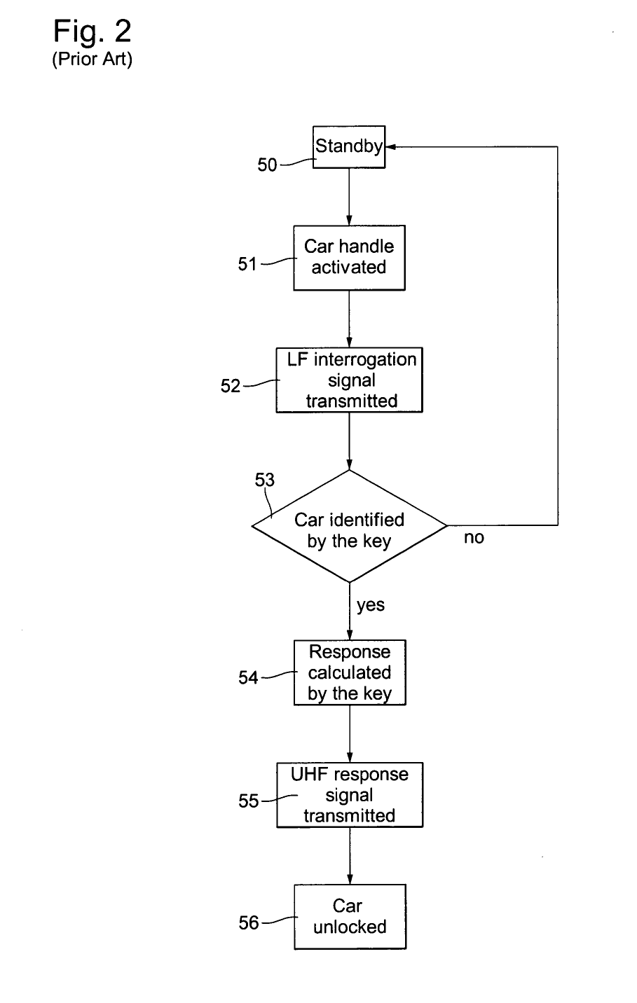

FIG. 2 shows a flow diagram of the steps of the access control method via a portable object, such as an electronic key, personalised to the vehicle so as to control the locking and unlocking of the doors and boot of said vehicle.

First of all, at step 50, the electronic key in the vehicle user's possession, is in the standby position. Once the handle of the vehicle has been gripped by the user at step 51, an interrogation signal LF is transmitted by the transmission means at step 52 at the command of the vehicle access control means. At step 53, the key, placed in the restricted zone around the vehicle, receives the interrogation signal and checks the identity of the vehicle via the received signal. If this encoded interrogation signal is not recognised by the key, the latter is again placed in the standby position at step 50. However, if the interrogation signal is recognised by the key, then a processing unit of the key at step 54 calculates a response signal. This high frequency response signal is transmitted by the antenna of the key transmission means at step 55. Finally, the vehicle reception means pick up this response signal in order to allow the access control means to command the unlocking or locking of the vehicle at step 56.

As shown in FIG. 1, when the person carrying the electronic key moves away from the vehicle out of the restricted zone, the key is no longer able to receive in interrogation signal originating from the vehicle. Thus, via intermediate relays 3 and 4, it is possible to remotely form a bridge between the person carrying portable object 2 and vehicle 1 to be unlocked. These intermediate relays are used generally by ill-intentioned persons to rob the vehicle easily, unknown to the user of the vehicle. The vehicle can thus be unlocked without having to steal said key and without forcing the locks of the vehicle.

The first intermediate relay 3, placed in restricted zone 5 around the vehicle, is capable of receiving a low frequency interrogation signal 6 via an antenna 31. This first relay converts low frequency signal LF to transmit a radiofrequency signal RF 7 via an antenna 32 to a second relay 4 in proximity to the person carrying portable object 2. This second relay converts the radiofrequency signal RF received by antenna 42 into a low frequency signal LF, which is the image of the interrogation signal transmitted by the vehicle. This low frequency signal 8 is transmitted by antenna 41 to portable object 2. The portable object receives, via antenna 21, the interrogation signal 8 provided by second relay 4. After receiving the interrogation signal, a high frequency response signal UHF 9 is transmitted by antenna 22, if the identity of the vehicle has been recognised. The second relay picks up this high frequency signal via antenna 43. The second relay converts the high frequency signal received by the portable object into a radiofrequency signal that is transmitted by antenna 42. The first relay receives the high frequency signal and converts it into a high frequency signal UHF, which is the image of the response signal calculated by the portable object. This high frequency response signal 10 is transmitted by antenna 33 to the vehicle so that antenna 12 of reception means 15 receives the response signal 10. Access control means 13, connected to the transmission means and to the reception means of the vehicle will command the unlocking of the vehicle doors and boot as soon as the response signal is received.

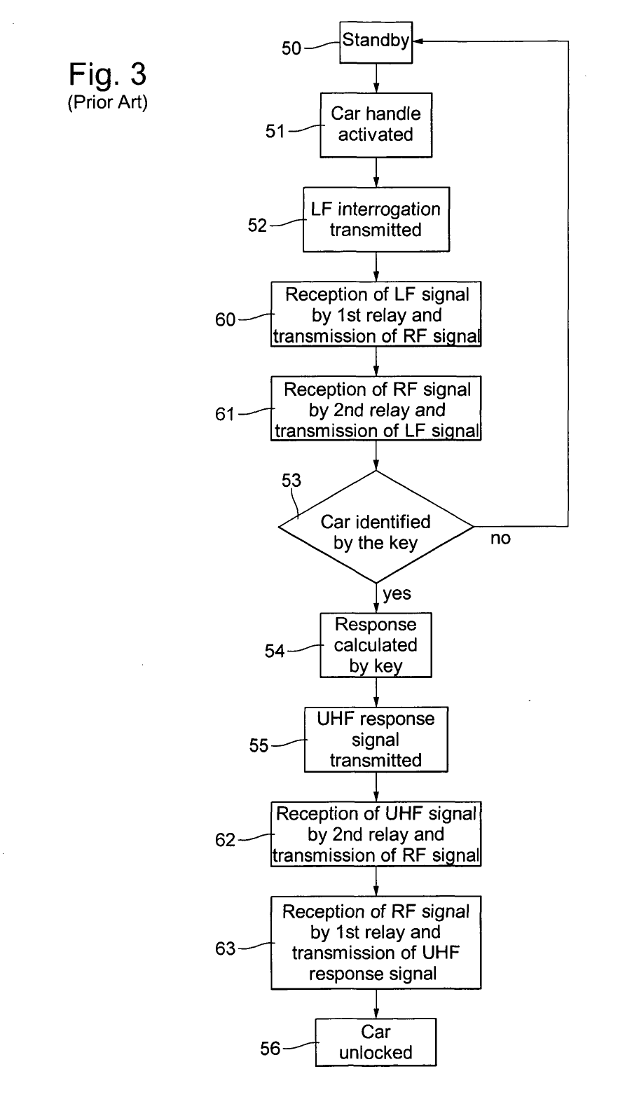

FIG. 3 shows a flow diagram of the access control method via a portable object, such as an electronic key, to the vehicle via intermediate relays for locking or unlocking the doors and boot of said vehicle. It is to be noted that the steps of this FIG. 3, which correspond to that of FIG. 2, bear the same reference numerals.

After the person carrying the first intermediate relay, has grasped the handle of the vehicle at step 51, the interrogation signal is transmitted via the vehicle at step 52. This interrogation signal is thus picked up by the first relay at step 60 in order to convert it into a radiofrequency signal. This conversion into a radiofrequency signal is necessary for long distance transmission. The second relay picks up the radiofrequency signal originating from the first relay at step 61 in order to convert it into a signal that is the image of the interrogation signal. The interrogation signal is transmitted to the electronic key.

At step 53, the key, in proximity to the second relay, receives the interrogation signal and checks the identity of the vehicle via this received signal. If the encoded interrogation signal is not recognised by the key, the latter is again placed in the standby position at step 50. However, if the interrogation signal is recognised by the key, a processing unit of the key then calculates a response signal at step 54. The antenna of the key transmission means transmits this high frequency response signal at step 55. At step 62, the second relay picks up this response signal in order to convert it again into a radiofrequency signal. This radiofrequency signal is transmitted from the second relay to the first relay. At step 63, the first relay, having received the radiofrequency signal, converts it into a high frequency signal that is the image of the response signal transmitted by the key. This high frequency signal is transmitted to the vehicle so that, at step 56, the access control means command the unlocking or locking of the vehicle.

The necessity of providing an access control method that forbids the use of such intermediate relays for controlling the locking or unlocking of parts or functions of the vehicle can thus be understood.

One solution for avoiding the use of such intermediate relays is mentioned in WO 01/25060. This document discloses a detection system that prevents an attack by intermediate relays for unlocking a vehicle unknown to the user of said vehicle. In order to do this, a frequency comparison of the signals transmitted and received by the vehicle is carried out in the vehicle so as to estimate the remote response time of the key. The frequency of the signal received by key is used to define the operations processed in the key and the frequency of the key response signal. The response signal frequency is for example more than 1000 times greater than the received signal frequency.

Once the car has transmitted the interrogation signal at a determined frequency, the frequency is varied in the car until the moment when the response signal from the key is received. The response signal frequency is divided to correspond to the frequency of the initially transmitted signal. Thus, a comparison is carried out between the response signal frequency and the time changed frequency in the car. The greater the distance separating the key from the car, the more the signal frequency in the car will have changed. One can thus detect, via this frequency change measurement, whether intermediate relays have been used to unlock said car in an unauthorised manner.

One drawback of the solution proposed in this document is the complexity of creating this frequency variation in the car in order to be able to estimate precisely the distance separating the key from the car. A distance value has to be given from which the electronic means estimate that the intermediate relays could have been used to unlock the car.

It is thus an object of the invention to provide a method for controlling access via a personalised portable object to a determined space preventing the use of intermediate relays and overcoming the drawbacks of the aforecited prior art.

This object, in addition to others, are achieved by the aforecited method which is characterized in that the transmitted and received encoded identification signal includes an analogue signature defined by at least one amplitude variation of the encoded signal envelope, said analogue signature being specific either to the portable object, or to the electronic means provided in the space, or to the pair formed by the personalised portable object and the electronic means provided in the space so as to authorise access to the space if said signature is recognised.

One advantage of the method is that with the use of an analogue signature of the encoded signal, this prevents any intermediate relays held by ill-intentioned persons from acting as a bridge between the object and the electronic means provided in the space to be accessed. These relays can only reproduce digital type signals, i.e. in which a binary data sequence is transmitted. By adding to the signals a specific analogue code, for example to the pair formed by the portable object and the electronic means provided in the space to be accessed, the relays can thus no longer exactly reproduce the encoded signals. The analogue signature, which also depends on the features of the transmission means and/or reception means, can be at least an amplitude variation of the encoded signal envelope. It may be an over-modulation of the encoded signal envelope. This analogue signature can also be defined as a function of an amplitude rise time and/or fall time of the envelope of the encoded signal at the beginning or end of the encoded signal. If the encoded signal includes a binary data sequence, the signature can be defined as a function of an amplitude rise and/or fall time between two binary elements of different value in the data sequence. The amplitude variation during the rise time and/or fall time can be linear or hyperbolic or random.

Preferably, the determined space is a vehicle and the portable object is an electronic key personal to the vehicle to be controlled. The electronic components of the key are powered by power supply means which include a standard battery or accumulator or photovoltaic cells or an oscillating weight generator.

The analogue signature is preferably inserted in the encoded interrogation signal transmitted by the vehicle to the electronic key. This interrogation signal includes a data sequence obtained by modulating the amplitude of the signal at a determined carrier frequency. This carrier frequency can be of the order of 125 kHz. Each binary element of the sequence is defined over a time period greater than the inverse of the carrier frequency. Upon reception of the encoded interrogation signal, when the key is in a restricted zone around the vehicle transmission means, an amplitude indicator of the key signal reception means provides dynamic envelope amplitude values of the encoded signal. With these received signal envelope amplitude values, it is possible to verify the encoded signal analogue signature. This verification is carried out in a micro-controller by comparing digitalised amplitude values with stored reference values.

Since the interrogation signal transmitted by the vehicle is at a low frequency, most of the calculating operations in the key micro-controller also occur at a low frequency that reduces the power consumption compared to high frequency processing. In a standby mode, operation is also at low frequency. However, once the analogue signature has been recognised, a high frequency response signal has to be transmitted to the vehicle to command the locking or unlocking of parts or functions of the vehicle. This high frequency carrier can be of the order of 433 MHz, which allows the vehicle to be controlled from a distance of between 10 to 30 meters. Since the electronic circuits of the key generating this high frequency signal only operate sporadically, the electrical power consumption remains low. The electrical power consumption can be of the order of 10 mA for a period of 100 ms.

It is also an object of the invention to make a portable object for implementing the access control method.

This object, in addition to other is achieved owing to the aforecited object which is characterized in that the processing unit is arranged to control the transmission means and/or reception means for the transmission and/or reception of an encoded identification signal with an analogue signature, which is defined by at least one amplitude variation of the encoded signal envelope, said analogue signature being specific either to the portable object, or the electronic means provided in the space, or to the pair formed by the object and the space to be accessed, such as a vehicle.

The objects, advantages and features of the access control method and the portable object for implementing the same will appear more clearly from the following description of at least one embodiment illustrated by the drawings, in which:

FIG. 1, already cited, shows schematically intermediate relays placed between the portable object and the vehicle for the unauthorised unlocking or locking of the vehicle;

FIG. 2, already cited, shows a flow diagram of the steps of the access control method via a personalised electronic key to the vehicle of the prior art for locking or unlocking parts or functions of the vehicle;

FIG. 3, already cited, shows a flow diagram of the steps of the access control method, via a personalised electronic key, to the vehicle of the prior art via intermediate relays for locking or unlocking parts or functions of the vehicle;

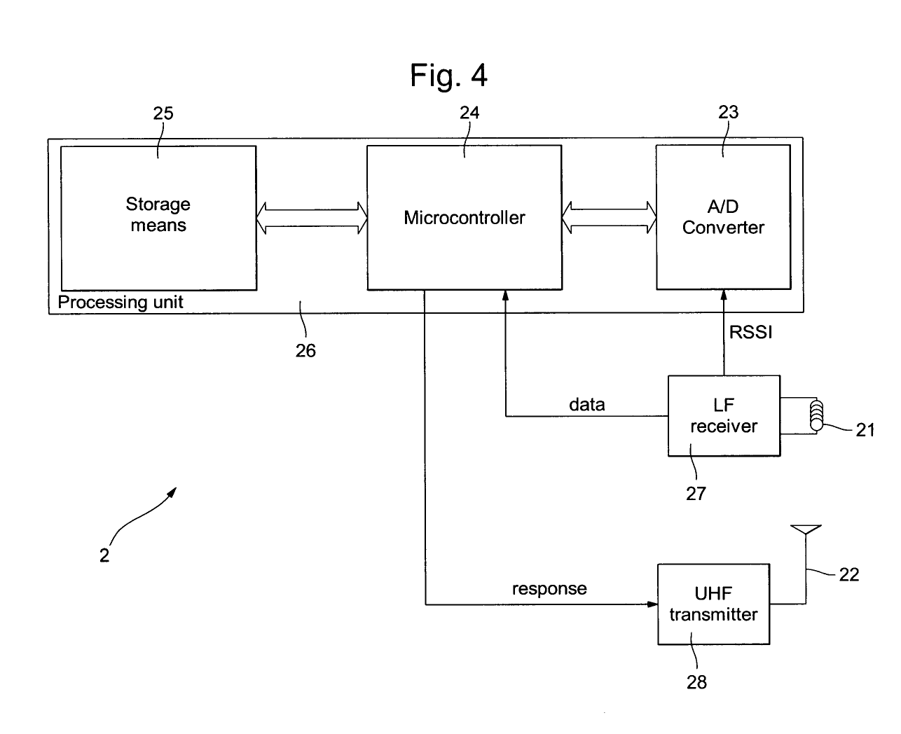

FIG. 4 shows schematically the electronic components of the portable object for implementing the access control method according to the invention;

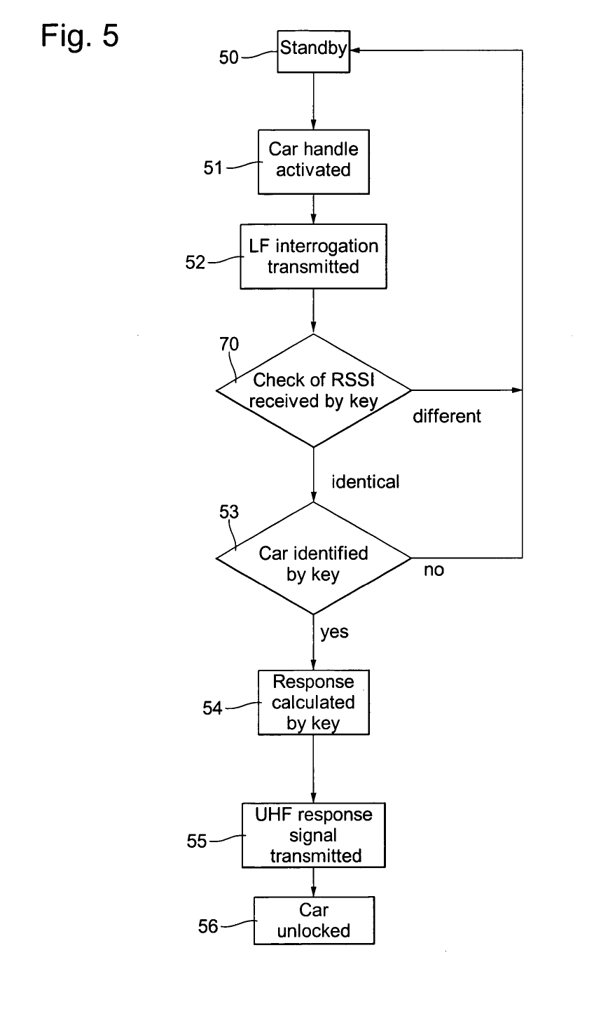

FIG. 5 shows a flow diagram of the steps of the access control method via a portable object, such as an electronic key, to a space, such as a vehicle, according to the invention;

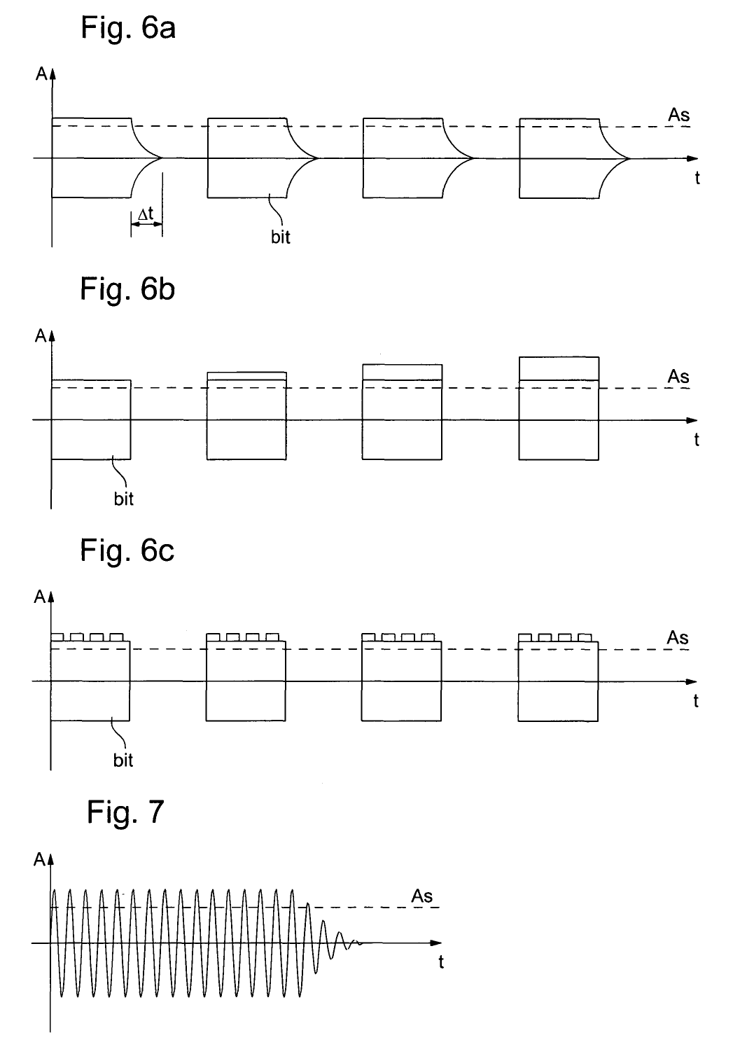

FIGS. 6a to 6c show graphs representing several types of analogue signature by time amplitude variation of the encoded signal envelope, which includes a binary data sequence for the access control method according to the invention; and

FIG. 7 shows a graph showing in more detail the encoded signal carrier ending in an analogue signature shown by the encoded signal envelope amplitude fall as illustrated in FIG. 6a.

A preferred embodiment of the method for controlling access to a determined space, such as a vehicle, with a portable object preferably formed by an active type electronic key, will be described hereinafter. Of course, the electronic components of the vehicle and the portable object, which are known to those skilled in the art in this technical field, will not all be described in detail.

As indicated hereinbefore, with reference to FIG. 1, the portable object 2 has to be in a restricted zone 5 around the electronic means of vehicle 1 to implement the access control method according to the invention. These electronic means include signal transmission means 11, 14 and/or reception means 12, 15.

Portable object 2 is preferably an active electronic key in which electrical power supply means allow all the electronic components contained in the key to be powered. These supply means can include a battery, an accumulator, photovoltaic cells, an oscillating weight generator or another well known electric energy source.

The electronic components of the key are shown schematically with reference to FIG. 4. As explained hereinbefore, the key has to have its own energy source, since it has to be able to respond with a high frequency encoded signal that can be of the order of 433 MHz. An electrical supply via an interrogation signal received at a low frequency of the order of 125 kHz for example, in the case of a passive key, is not sufficient to allow generation of the high frequency encoded signal transmitted by the key.

Electronic key 2 essentially includes a signal processing unit 26 connected to signal reception means 21, 27, and to signal transmission means 22, 28. The electrical power consumption of the key is of the order of 5 μA in standby mode 99% of the time, and of the order of 10 mA for a period of 100 ms during transmission of the high frequency encoded signal.

The reception means are formed of a receiving antenna 21 for receiving a low frequency encoded signal originating from the vehicle, and a receiver 27. The encoded interrogation signal, received by the reception means, includes a binary data sequence. LF receiver 27, receiving the encoded signal, supplies the binary data sequence to a micro-controller 24 of processing unit 26. This LF receiver 27 also includes a received signal strength indicator (RSSI) supplying dynamic analogue envelope amplitude values for the received encoded signal to an analogue-digital converter 23 of processing unit 26. This analogue-digital converter 23 digitalises the amplitude values provided by the indicator clocked by a clock signal of the order of 125 kHz. The digitalised amplitude values, defining in part the analogue signature, are compared to amplitude reference values. These reference values are stored in storage means 25 of processing unit 26, which are connected to the micro-controller.

Since the amplitude of the encoded signal is dependent upon the distance between the vehicle and the key, it is more the derivatives of the encoded signal envelope or the amplitude variations, which are digitalised and compared in micro-controller 24 with stored reference values. After sampling at a determined frequency in converter 23, it is possible to evaluate these derivatives or these variations in order to identify the pair formed by the key and the vehicle.

LF receiver 27, which includes the amplitude indicator RSSI, can be the electronic component referenced EM4083, produced by EM Microelectronic-Marin SA, located at Marin in Switzerland. Micro-controller 24, used particularly for the amplitude value comparison and for the response signal calculation, can be the electronic component referenced EM6640, also produced by EM Microelectronic-Marin SA, located at Marin in Switzerland.

Once the analogue signature has been verified in micro-controller 24, a response signal calculation is carried out in said micro-controller so as to command transmission of the response signal to transmission means 22, 28. These transmission means are formed of a UHF transmitter 28 and an antenna 22. Since the elements forming the transmitter are well known in this technical field, they will not be explained hereinafter. However, for transmission of the high frequency response signal, a voltage controlled oscillator of the transmitter is generally used, which consumes a lot of electric energy. Thus, UHF transmitter 28 is not continually switched on in the electronic key so as to avoid discharging the energy source comprised in the key too quickly. This transmitter is only switched on if micro-controller 24 has recognised the analogue signature of the received interrogation signal. This analogue signature specifically defines the pair formed by the personalised key and the vehicle, since it depends upon specific features of the transmission means and reception means of the key and the vehicle.

The encoded interrogation signal transmitted by the vehicle includes a carrier at a frequency of 125 kHz on which a binary data sequence is obtained via amplitude modulation of the carrier envelope. Each binary element of the sequence is thus defined over a time period greater than the inverse of the carrier frequency. Each binary element takes the value 1, respectively 0, when the envelope amplitude level of the encoded signal binary element is greater, or respectively less than a determined threshold amplitude level. At this low frequency, the encoded interrogation signal is only picked up at a distance of less than 2 meters, which defines the restricted zone around the vehicle.

Of course, the carrier frequency of the encoded signal transmitted by the vehicle can be different from 125 kHz. One could envisage fixing this carrier frequency for example at 90 kHz.

The response signal transmitted by the key to the vehicle includes a carrier at a frequency of the order of 433 MHz. Normally, at this frequency, the response signal is not encoded by amplitude modulation, since well known multiple path problems would influence recognition of the transmitted encoding.

As for the case of the low frequency encoded signal, the carrier frequency of the response signal may be different from 433 MHz. The value of this response signal carrier frequency may be dependent upon certain regulations in the country where the access control method is being applied. With such a carrier frequency, it is possible to control the parts or functions of the vehicle from a distance of up to 30 meters.

FIG. 5 shows a flow diagram of the steps of the vehicle access control method via a personalised electronic key for locking or unlocking the doors and boot of said vehicle according to the invention. It is to be noted that the steps of this FIG. 5, which correspond to those of FIG. 2, bear the same reference numerals.

At step 50, the electronic key carried by the vehicle user is in the standby position. Once the handle of the vehicle has been gripped by the user's hand at step 51, a LF interrogation signal is transmitted by the transmission means at step 52 upon the command of the vehicle access control means. The electronic key, placed in the restricted zone around the vehicle, receives the encoded interrogation signal at step 70. At this step 70, the RSSI of the RF receiver supplies analogue amplitude values to the converter. The converter digitalises these amplitude values in order to allow the digitalised amplitude values to be checked in the micro-controller, defining the analogue signature of the received signal, with stored reference values. If the analogue signature is not recognised, the electronic key passes to standby at step 50. However, if the analogue signature is recognised, the vehicle is identified at step 53. If the vehicle is not recognised, the key is again placed in standby position at step 50. If the vehicle to be controlled is recognised, a response signal is calculated by a processing unit of the key at step 54. This high frequency response signal is transmitted by the antenna of the key transmission means at step 55. Finally, the vehicle reception means pick up this response signal in order to allow the access control means to command the unlocking or locking of the vehicle at step 56. It may also be arranged for the vehicle start function to be commanded at this step 56. In this latter case, instead of gripping the handle as explained hereinbefore, the user's hand touches for example the gear shift lever cover.

Of course, it is not obligatory for example to grip the vehicle handle for the access control method to be operated. Any other means for detecting the presence of the key in proximity to the vehicle can be envisaged to command the vehicle to transmit an encoded interrogation signal with an analogue signature. Acoustic or optical means can, for example, be used to command transmission of the vehicle encoded interrogation signal.

As mentioned hereinbefore, the analogue signature of the encoded signal is defined by at least one encoded signal envelope amplitude variation. Several non-limiting examples of analogue signatures are shown in FIGS. 6a to 6c. The signals shown in these FIGS. 6a to 6c are for example those provided by the indicator RSSI.

In these FIGS. 6a to 6c, an encoded interrogation signal transmitted by the vehicle includes a data sequence obtained by amplitude modulation of the encoded signal envelope. This data sequence is defined by a succession of binary elements. One binary element represents the value 1 when the envelope amplitude is above the threshold amplitude level As, whereas this binary element represents the value 0 when the envelope amplitude is below level As. Preferably, the envelope amplitude defining binary element 0 is close to 0. In a simplified manner in these Figures, the data sequence includes a succession of binary elements of different value. The sequence 10101010 is shown in FIGS. 6a to 6c. Normally, this data sequence can represent a vehicle identification code.

In FIG. 6a, the analogue signature transmitted and received in the encoded identification signal is defined as a function of an encoded signal envelope amplitude rise time and/or fall time At from the passage between two binary elements of different value in the data sequence. The amplitude variation during the rise time and/or fall time can be linear or hyperbolic or random so as to specifically represent the pair formed by the vehicle and the personalised key. As previously described, the digitalised values provided by the converter of the processing unit define derivatives of the encoded signal envelope rise and/or fall curve to be compared with stored reference values.

It is to be noted that this analogue signature depends particularly on specific features of the transmission means and reception means of the key and the vehicle. The envelope amplitude rise or fall defining the signature can be obtained by an RC type resonator.

In the case of a signal whose encoding is not generated by amplitude modulation, the analogue signature can be defined at the beginning or the end of the encoded signal, as a function of the encoded signal envelope amplitude rise and/or fall time.

In FIG. 6b, the analogue signature transmitted and received in the encoded identification signal is defined by an amplitude over-modulation of the encoded signal envelope. This over-modulation is applied, for example, to the binary elements representing the value 1 of the data sequence. An amplitude rise in the binary elements with a value of 1 is shown in this Figure. However, it is also possible to provide a fall in the envelope amplitude of the series of said binary elements with a value of 1 in the data sequence.

In FIG. 6c, the analogue signature transmitted and received in the encoded identification signal is defined by an over-modulation of each binary element. Preferably, this amplitude over-modulation is only applied to the binary elements with a value of 1 in the data sequence. Thus, several amplitude variations per binary element with a value of 1 are observed after passage through the converter and comparison in the micro-controller of the processing unit. This over-modulation of each binary element with a value of 1 can be a sinusoidal variation or a variation with rectangular pulses in the envelope amplitude.

Since the data sequence is defined by amplitude modulation of a carrier of the encoded signal, FIG. 7 shows more precisely the shape of the encoded signal in the case of an analogue signature shown in FIG. 6a.

From the description that has just been given, multiple variants of the access control method and the portable object can be conceived by those skilled in the art without departing from the scope of the invention. The principle of the analogue signature on an encoded signal transmitted by a transmitter to a receiver can also be applied to a space, such as a strong-room or an access door to a secret place. In this case, the portable object can be a watch, a badge, a portable telephone, a smart card with or without an electric power source. Likewise, the analogue signature can also be transmitted in a response signal transmitted by the portable object.

What is claimed is

1. A method for controlling access via a personalised portable object to a determined space via wireless transmission of an encoded identification signal, electronic means, which include access control means connected to signal reception means and/or transmission means, provided in the space, and the portable object including a processing unit connected to signal transmission means and/or reception means, the method including steps of:
transmitting an encoded identification signal via the transmission means of the portable object or respectively via the transmission means provided in the determined space,
receiving the encoded identification signal via the reception means provided in the space or respectively via the reception means of the portable object, when the object is in a restricted zone around electronic means provided in the space, and
verifying the encoded signal in the access control means or respectively in the processing unit for authorising access to the space,
wherein the transmitted and received encoded identification signal includes an analogue signature defined by at least one amplitude variation of the encoded signal envelope, said analogue signature being specific either to the electronic means provided in the space, or to the portable object, or to the pair formed by the personalised portable object and the electronic means provided in the space so as to authorise access to the space if said signature is recognised.

2. The method according to claim 1, wherein the amplitude variation defining the analogue signature is obtained by an over-modulation of the encoded signal envelope.

3. The method according to claim 1, wherein the encoded identification signal is defined by a binary data sequence obtained by amplitude modulation of the signal with a determined carrier frequency, each binary element of the sequence being defined over a time period greater than the inverse of the carrier frequency, and wherein each binary element takes the value 1, respectively 0, when the envelope amplitude level of the encoded signal binary element is greater, or respectively less than a determined threshold level.

4. The method according to claim 3, wherein an amplitude over-modulation of the encoded signal envelope is applied to the binary elements of the data sequence corresponding to the value 1 by the envelope amplitude rise or fall of the series of said binary elements of the sequence, or by several envelope amplitude variations of said binary elements with a value of 1, and wherein the amplitude level of the envelope of the encoded signal for a binary element corresponding to the value 0 is close to 0.

5. The method according to claims 1 or 3, wherein analogue signature transmitted and received in the encoded identification signal is defined as a function of an encoded signal envelope amplitude rise time and/or fall time at the beginning or the end of the encoded signal, or as a function of an encoded signal envelope amplitude rise and/or fall time from the passage between two binary elements of different value of the data sequence, the amplitude variation during the rise and/or fall time being linear or hyperbolic or random.

6. The method according to claim 1, for controlling access by a personalised portable object, such as an electronic key, to a vehicle so as to control the locking or unlocking of parts or functions of the vehicle, the method being wherein it includes the steps of:
transmitting via transmission means of the vehicle a first encoded signal defined as an interrogation signal with an analogue signature specific to the pair formed by the personalised object and the vehicle,
receiving the interrogation signal via reception means of the object, when the object is located in a restricted zone around the transmission means of the vehicle,
comparing the received analogue signal with a reference signature stored in the processing unit of the object,
calculating a second encoded signal defined as a response signal in the processing unit of the object if the specific analogue signal is recognised, and
transmitting the response signal so as to command the locking or unlocking of parts or functions of the vehicle.

7. The method according to claim 6, wherein an analogue signal specific to the pair formed by the vehicle and the personalised portable object is transmitted with the first and second encoded signals.

8. The method according to claim 1, wherein a received signal strength indicator for the encoded signal envelope, provided in the reception means of the object, such as an electronic key, or the space, such as a vehicle, supplies dynamic amplitude values for the encoded signal envelope to the control means or to the processing unit to compare the received analogue signature with a stored reference signature.

9. The method according to claim 8, wherein the processing unit of the object and/or the control means of the space include an analogue-digital converter, a signal processing micro-controller and storage means that include, in particular, a ciphering algorithm and a reference signature, wherein the amplitude values provided by the indicator are digitalised by the analogue-digital converter, wherein the converter clocked by a clock signal supplies digitalised amplitude values for the received encoded signal envelope to the micro-controller, and wherein the micro-controller carries out a comparison between the digitalised amplitude values with the amplitude values of the stored reference signature.

10. A personalised portable object for implementing the method according to claim 1, the object comprising a processing unit connected to signal transmission means and/or reception means, wherein the processing unit is arranged to control the transmission means and/or the reception means for the transmission and/or reception of an encoded identification signal with an analogue signature, which is defined by at least one amplitude variation of the encoded signal envelope, said analogue signature being specific either to the electronic means provided in the space, or to the portable object, or to the pair formed by the object and the electronic means provided in the space to be accessed, such as a vehicle.

11. The object according to claim 10, wherein it includes high frequency signal transmission means and low frequency signal reception means, and wherein the reception means include a received signal strength indicator for the received encoded signal envelope to provide dynamic amplitude values for the encoded signal envelope to the processing unit to compare the received analogue signature with a reference signature stored in storage means of the processing unit.

12. The object according to claim 11, wherein the processing unit includes an analogue-digital converter for digitising the amplitude values provided by the indicator, and a signal processing micro-controller for comparing the digitalised amplitude values provided by the converter with amplitude values of the stored reference signature.

13. The object according to claim 10, wherein the object is an electronic key with electric power supply means for the integrated electronic components, the supply means including a battery or an accumulator or photo-voltaic cells or an oscillating weight generator.
